(19) United States
(12) Patent Application Publication
(10) Pub. No.: US 2012/0328554 A1
(43) Pub. Date: Dec. 27, 2012

(54) Composition for the Preparation of an Anti-Biofouling Coating

(76) Inventors: Alexandre Beigbeder, Laval (FR); Redha Bella, Lyon (FR); Daniel Bonduel, Horrues (BE); Michael Claes, Romsee (BE); Philippe Dubois, Braives (BE); Rosica Mincheva, Liege (BE)

(21) Appl. No.: 13/518,266

(22) PCT Filed: Dec. 10, 2010
(86) PCT No.: PCT/EP2010/069345

§ 371 Date: Sep. 10, 2012

(30) Foreign Application Priority Data
Dec. 22, 2009 (EP) 09015835.3

(51) Int. Cl. C09D 5/10; B82Y 30/00

(52) U.S. Cl. 424/78.09; 977/742; 977/752; 977/902

(57) ABSTRACT

The present invention is related to a composition for the preparation of an anti-biofouling coating comprising: -a polymer fraction essentially consisting of polysiloxane; -a curing agent; -carbon nanotubes; -a metal-free catalyst consisting of an organic acid.

### FIELD OF THE INVENTION

The present invention relates to a composition for the preparation of a polysiloxane-based coating comprising carbon nanotubes.

The present invention also relates to the use of such compositions for the preparation of an anti-biofouling coating, and more particularly, the use of such coatings for paintings in a marine environment.

### PRIOR ART

Biological contamination by a marine environment, which is known as biofouling, whether it is micro-organic or macro-organic, is a major problem, not only for land-based installations that use a large amount of sea water, but also for offshore installations and more generally for any object in permanent or prolonged contact with sea water, for instance boat hulls and aquaculture ropes, cages and nets. Indeed, marine organisms, such as algae, shellfish and other crustaceans, adhere to and then grow on the exposed surfaces, which impairs the correct functioning and deteriorates said installations or objects. In particular, they may, for example, block the inlets of sea water intake valves and thus reduce the water uptake capacity of land-based installations using sea water, or they may reduce the speed of ship hulls and increase their fuel consumption by adhering to said hulls.

Marine anti-biofouling and fouling release compositions are usually applied to surfaces in permanent contact with a marine environment to control or prevent the adhesion or growth of such marine organisms or alternatively to facilitate their removal. Such a composition generally contains one or more compounds that are toxic to the marine organisms that adhere to the submerged surfaces that need to be protected. The drawback of these toxic compounds is that they need to be released into the marine environment by the marine anti-biofouling coating or paint over a relatively long period in order to be sustainably effective. As a result, such a composition is always polluting, all the more so since it generally comprises compounds such as mercury, lead, tin or arsenic.

Some marine anti-biofouling coatings or paints comprise copper-based compounds, which have been known for a long time for their toxicity to phytoplankton and other marine organisms. The copper may be, for example, in the form of cuprous oxide, copper dioxide, copper thiocyanate, copper acrylate, flaked copper powder or copper hydroxide and may be released into the marine environment in the form of copper ions. Unfortunately, the drawback of this solution is that it does not last long. Specifically, once the copper content of the coating has been depleted, the coating is no longer effective. Usually, the compositions have very high doses of copper in order to give the coating a longer life. However, the use of high concentrations of copper may also lead to pollution of the marine environment.

The trend in terms of environmental regulations in the coming years will be the banning of the use of marine anti-biofouling coatings such as those mentioned previously, but also those comprising tin(IV) derivatives, such as tin oxides or tributyltin, which are all environmentally toxic and hazardous, in favour of alternative coatings that are more environment-friendly.

Document WO 2008/046166 discloses an alternative to usual anti-biofouling coatings, using carbon nanotubes dispersed in a polysiloxane matrix. In the same way, a lot of catalysts for curing polysiloxane resins are known in the prior art, but the most commonly used are those based either on organotin-based or platinum-based compounds. However, due to toxicological problems and cost considerations, the use of such catalysts should be avoided in large-scale coating applications such as their application in anti-biofouling coating of boat hull and the like.

### AIMS OF THE INVENTION

The present invention aims to provide a composition for the preparation of an anti-bioufouling coating that does not have the drawbacks of the prior art.

More particularly, the present invention aims to provide a composition for the preparation of an anti-bioufouling coating without any metallic catalyst.

The terms “anti-biofouling composition” are used to define a precursor composition for the preparation of a coating having anti-biofouling properties, fouling release properties or a combination thereof.

### SUMMARY OF THE INVENTION

The present invention is related to a composition for the preparation of an anti-biofouling coating comprising or consisting of:
a polymer fraction essentially consisting of polysiloxane;
a curing agent;
carbon nanotubes;
a metal-free catalyst consisting of an organic acid.

According to particular preferred embodiments, the invention further discloses at least one or a suitable combination of the following features:
the catalyst concentration in the composition is comprised between 2 and 10 wt %, preferably between 4 and 6 wt % and more preferably the catalyst concentration in the composition is about 5 wt %;
the organic acid is halogenated;
the organic acid is fluorinated;
the organic acid comprises or consists of trifluoroacetic acid (TFA);
the organic acid is chlorinated;
the organic acid comprises or consists of trichloroacetic acid (TCA);
the curing agent is vinyl triisopropenoxysilane;
the amount of catalyst is comprised between 1 and 10 wt %, preferably between 1 and 5 wt % of the total composition;
the amount of carbon nanotubes is comprised between 0.05 and 1 wt % of the total composition, preferably between 0.1 and 0.5 wt %;
the carbon nanotubes are multiwall carbon nanotubes (MWCNTs);
the polysiloxane is polydimtehylsiloxane;
the molecular weight of the polydimethylsiloxane is comprised between 15000 and 25000 g/mol, preferably about 20000 g/mol;
the polydispersity of the polydimethylsiloxane is about 1.85;
the weight ratio between the polysiloxane and the curing agent is about 1:19.

A second aspect of the invention is related to a method for the protection of items in a marine environment against bio-fouling comprising the step of applying on said items the composition according to the above-mentioned features and embodiments.

The present invention also discloses a method for the protection of items in a marine environment against bio-fouling comprising the step of applying on said items a coating composition comprising polysiloxane, a curing agent and trifluoroacetic acid.

### BRIEF DESCRIPTION OF THE DRAWINGS

FIG. 1 represents a coating surface comprising carbon nanotubes.

FIG. 2 represents the amount of spores (or biomass) of the marine alga Ulva that have colonized different samples described in the examples.

FIG. 3 represents the variation of the removal rate of the marine alga Ulva on different samples described in the examples.

FIG. 4 represents the total biomass remaining after washing different samples described in the examples.

### DETAILED DESCRIPTION OF THE INVENTION

The present invention discloses a composition for the preparation of an anti-biofouling coating comprising:
a polymer fraction essentially consisting of polysiloxane;
a curing agent;
carbon nanotubes;
a metal-free catalyst consisting of an organic acid.

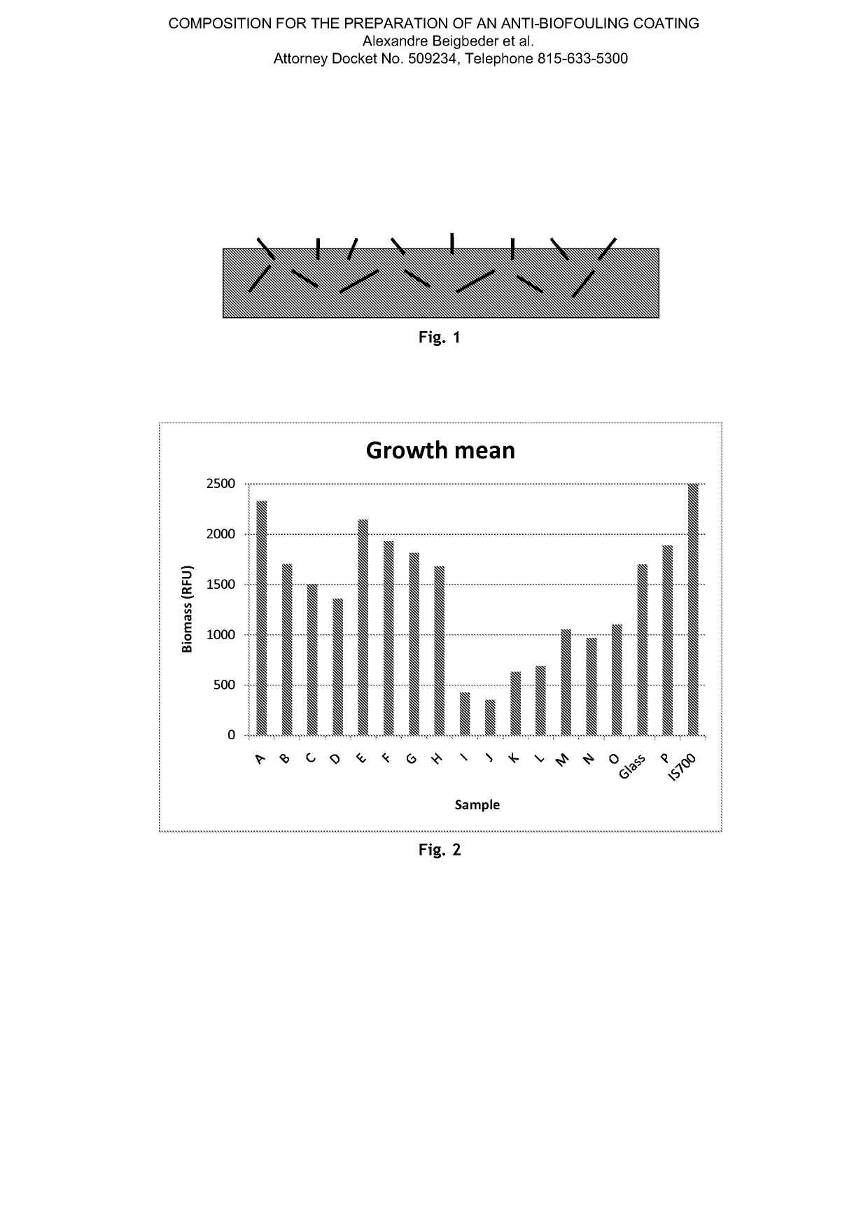

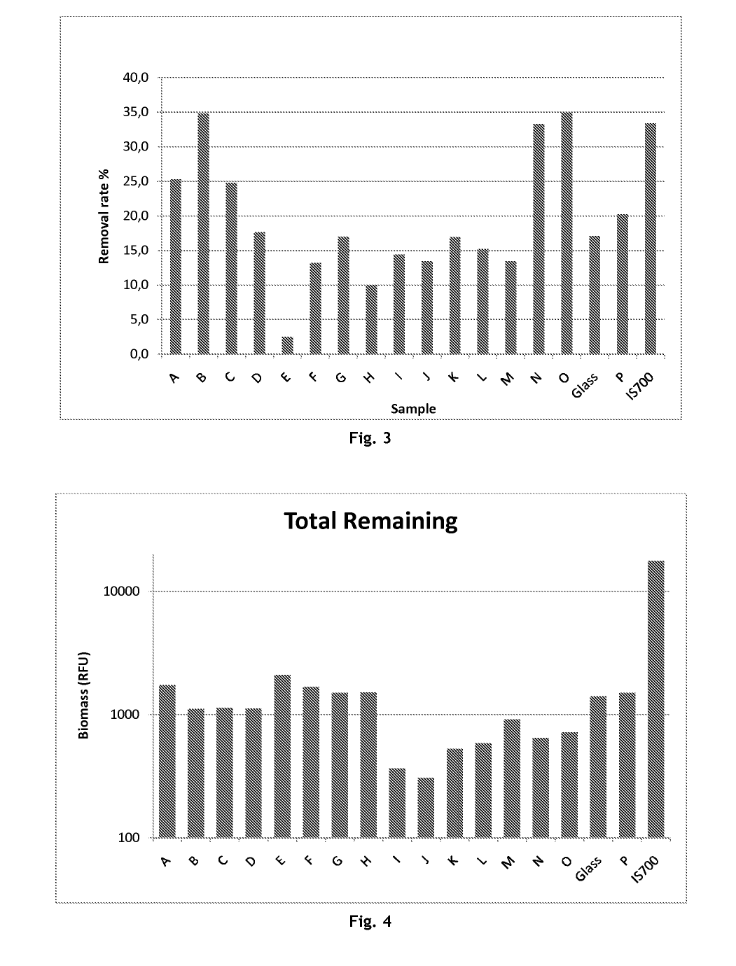

The first objective of the present invention is to avoid the use of heavy metal catalyst in polysiloxane coatings for environmental reasons. Surprisingly, among all organic catalysts available, it has been shown that the use of organic acid catalysts does not only solve the environmental problem of leaching metal catalyst in a marine environment, but also improves the fouling properties of MWCNTs comprising coatings, as shown in FIGS. 2 and 3. Preferably, the organic acid catalyst is a halogenated catalyst, and more preferably a fluorinated catalyst or a chlorinated catalyst.

Even better, even without the presence of carbon nanotubes, it can be seen in FIG. 3 that the cleaning of fouled surfaces is substantially improved by the replacement of dibutyltin dilaurate by an organic acid catalyst.

Surprisingly, the influence of the catalyst concentration on the fouling properties of the obtained coating shows a non-linear behaviour with an optimum relative catalyst concentration of about 5 wt %. This can be seen on FIG. 2, where the samples I, J, and K have the same composition except for the catalyst concentration, which varies from 2 to 10%, the best results being obtained with 5 wt % catalyst. In comparison with the corresponding composition without carbon nanotubes (samples M, N and O), it should be noticed that the relative improvement obtained by varying the catalyst concentration is much higher in the presence of carbon nanotubes: about 17% reduction in growth when increasing the catalyst concentration from 2 wt % to 5 wt % in the presence of MWCNTs, and about 8% for the same variation in the absence of MWCNTs.

In order to simplify the curing process, the polymer fraction of the invention essentially consists of polysiloxane, preferably polydimethysiloxane (PDMS). By essentially consisting of polysiloxane, it is meant that small amounts of copolymer may eventually be incorporated, without substantially changing the general properties of the obtained coating. Such additional polymeric modifier may for example be incorporated in order to fine-tune the viscosity of the obtained composition.

In order to optimise the viscosity of the composition to ease its application on items to be coated, the molecular weight of the polysiloxane is preferably comprised between 15000 and 25000 g/mol, more preferably about 20000 g/mol.

Polydispersity (PDI) also allows to fine-tune the rheological properties of the composition. Preferably, the polydispersity of the polysiloxane is about 1.85. PDI calculated is the weight average molecular weight divided by the number average molecular weight. It indicates the distribution of individual molecular masses in a batch of polymers.

### Examples

### Table 1

### Raw Materials Used in the Examples

| | | Main characteristic |
|---|---|---|
| Materials | Description | features |
| polysiloxane 1 | Silanol-terminated PDMS | M̅ₙ = 20300 g/mol; PDI = |
| | | 1.85 ^{(a)} |
| polysiloxane 2 | Silanol-terminated PDMS | |
| | containing 0.5 wt. % | |
| | MWCNTs | |
| VTiPOS | vinyl triisopropenoxysilane | MW = 226.36 g/mol; ρ = |
| | curing agent | 0.926 g/cm^{3 (b)} |
| Si | Hexamethyldisilazane- | Amorphous, d = 20 nm, |
| | treated silicone dioxide | SA = 150-200 m²/g, ρ = |
| | nanoparticles | 2.2 g/cm^{3 (b)} |
| PDMS-CH₃ | Trimethylsiloxy-terminated | M̅ₙ = 5970 g/mol ^{(b)} |
| | PDMS | |
| DBTL | Dibutyltin dilaurate | MW = 631.56 g/mol, ρ = |
| | | 1.066 g/cm^{3 (b)} |
| TFA | Trifluoroacetic acid | MW = 114.02 g/mol, ρ = |
| | | 1.489 g/cm^{3 (b)} |
| DCA | Dichloro acetic acid | |
| TCA | Trichloro acetic acid | MW = 163.4 g/mol, ρ = |
| | | 1.630 g/cm^{3 (b)} |
| PA | Phosphoric acid (85% sol.) | MW = 98 g/mol, ρ = |
| | | 1.1.685 g/cm^{3 (b)} |
| NA | Nitric acid (60% sol.) | MW = 63.012 g/mol, ρ = |
| | | 1.513 g/cm^{3 (b)} |
| HCl | Chloridric acid (36% sol.) | MW = 36.46 g/mol, ρ = |
| | | 1.477 g/cm^{3 (b)} |
| SA | Sulfuric acid | MW = 98.08 g/mol, ρ = |
| | | 1.840 g/cm^{3 (b)} |

^{(a)} As determined by GPC in THF, relative to PMMA standards.
^{(b)} As claimed by the supplier.

All listed materials are used as received.

For the preparation of all examples (see the following Tables) two parts (Part A and Part B) were formulated according to the commercially available two-part PDMS-based resins. In a typical experiment, part A consists of silanol-terminated PDMS (Polysiloxane 1), hexamethyldisilazane-treated silicone dioxide (Si) and a curing agent (VTiPOS). According to the supplier's recommendations, the polysiloxane/VTiPOS ratio is fixed to 95/5 (wt %/wt %). The amount of Si is fixed to 2 wt % in the final formulations in order to regulate the viscosity.

In the case where Polysiloxane 2 was used (0.5 wt % MWCNTs) for the binary coating preparation, the MWCNTs contribution to the final mixture was adjusted to 0.1 wt % by diluting said MWCNTs with Polysiloxane 1.

For all compositions, all components were mechanically mixed at 1200 rpm for 30 min.

In all experiments, part B consists of PDMS-CH₃ added with the requested amount of catalyst in order to reach the final composition as marked in Tables 2 to 4.

For all sample preparations, parts A and B are mixed together in a weight ratio of 10:1 in order to obtain a cross-linked PDMS via a condensation reaction at room temperature (after a 48 h reaction time, which is a predefined time selected to compare the studied formulations).

The samples were characterized in terms of viscosity (η, cP) of the binary compositions before cross-linking, tensile modulus (E, MPa) and equilibrium degree of swelling (G_{sw}) and the extractable value (E_{sw}) of the cross-linked samples (see the following Tables).

The viscosity of the compositions was determined with a Brookfield DV-II viscometer at 25±0.1° C. and at a rate of 1 rpm.

The tensile modulus of the samples was analysed at room temperature with a dynamic mechanical analyser DMA (TA Instrument 2980) operating in tensile strain-sweep mode. A frequency of 1 Hz, a preload of 0.1 N and an amplitude from 0.5 to 27 mm were used. The results are the average of at least three measurements.

For the swelling tests, pre-weighed dry cylindrical samples of the cross-linked formulations were immersed in 100 ml of heptane at room temperature during 48 h. To determine the equilibrium degree of swelling (G_{sw} %), samples were taken out at regular time intervals, the heptane remaining in excess at the sample surface was gently removed with filter paper and the swollen samples were weighed. After reaching the equilibrium, the samples were dried during 16 h at 50° C. under vacuum. The E_{sw}. the G_{sw} % and the E_{sw} were calculated as follows:

$${G}_{sw} ( \% ) = \frac{( {w}_{1} - {w}_{0} )}{{w}_{0}} \times 100$$

$${E}_{sw} ( \% ) = \frac{( {w}_{0} - {w}_{2} )}{{w}_{0}} \times 100$$

where w₀ is the weight of the sample after curing, before immersion in heptane and drying under vacuum;
where w₁ is the weight of the sample after immersion in heptane during 48 h;
where w₂ is the weight of the sample after drying during 16 h at 50° C. under vacuum.
The values of G_{sw} and E_{sw} are the average of at least three samples. It can be seen in table 3 that all samples catalysed with an organic acid in the presence of carbon nanotubes were almost fully cross-linked, as they were not dissolved by hexane, and the level of extractible matter was limited to low values. Regarding inorganic acids, only samples catalysed with sulphuric acid were not fully dissolved by the hexane, but the level of extractible (up to about 56%) showed insufficient levels of cross-linking.

In the case of samples containing no carbon nanotubes (table 2), the situation is more complex, as TCA does not fully cross-link the polysiloxane at low levels of catalyst.

The biofouling behavior of such coatings has been checked in an assay described below.

The assay procedure regarding the studies of cellular colonization is in accordance with section 4.2 of the Biological Workshop Manual (BWM, AMBIO Biological evaluation workshop, University of Birmingham UK 21-22 Apr. 2005; Ulva Sporeling Growth). Spores are released from plants collected from the seashore. The concentration of spores is adjusted to a standard concentration, for example 1×106 spores/ml. Each coating sample (table 4) is immersed in 30 liters of distilled water for one week, and then in artificial sea water for 1 hour in darkness, in the presence of the colonizing cells (spores of the marine alga Ulva) before the growth medium is added. The samples are then incubated in an illuminated incubator for 6 days, the medium being refreshed every 2 days. The biomass on each slide is quantified by measuring the amount of chlorophyll present. This is quantified directly through in situ fluorescence using for example a plate reader.

After 6 days of growth, the amount of cells (or biomass) that adhere to the surfaces is evaluated by in situ fluorescence determination (section 4.2.1 of the Biological Workshop Manual, AMBIO Biological evaluation workshop, University of Birmingham, UK, 21-22 Apr. 2005) by virtue of the auto-fluorescence of the photosynthetic pigment chlorophyll by means of a fluorescent reader which emits light of a wavelength of 430 nm, exciting the chlorophyll contained within the chloroplasts of the algal cells growing on the sample surface, and then measures the 630 nm light, which is emitted as the pigment returns to ‘resting state’. This method of biomass quantification has the advantage of being relatively quick and non-destructive.

This procedure has been applied to coatings of the present invention. Results are summarized in FIG. 2. In order to compare the results to standard surfaces, an uncoated glass plate and a glass plate coated with a commercial coating IS 700 (Intersleek 700 from Akzo Nobel) have been tested.

The samples are then washed out and the removal rate is measured. The removal rate obtained is represented in FIG. 3. The total remaining biomass after washing the samples is represented in FIG. 4.

TABLE 2
Examples of condensation-cured formulations without carbon nanotubes

| | | | Catalyst | | | |
|---|---|---|---|---|---|---|
| No | Additive | Catalyst | Concentration | Result | G_{sw} | E_{sw} |
| 1 | Polysiloxane 1 | TFA | 1% | Crosslinked | 295.5 ± 7.9 | 12.7 ± 0.2 |
| 2 | | | 2% | Crosslinked | 398.2 ± 3.8 | 14.9 ± 0.4 |
| 3 | | | 5% | Crosslinked | 257.4 ± 0.8 | 11.1 ± 0.5 |
| 4 | | | 10% | Crosslinked | 256.6 ± 1.3 | 9.9 ± 0.4 |
| 5 | Polysiloxane 1 | DCA | 1% | Crosslinked | 237.0 ± 4.5 | 11.1 ± 0.7 |
| 6 | | | 2% | Crosslinked | 187.4 ± 1.5 | 12.6 ± 0.7 |
| 7 | | | 5% | Crosslinked | 189.7 ± 3.7 | 11.1 ± 1.7 |
| 8 | | | 10% | Crosslinked | 198.5 ± 7.1 | 11.4 ± 1.1 |
| 9 | Polysiloxane 1 | TCA | 1% | Not crosslinked | / | / |
| 10 | | | 2% | Not crosslinked | / | / |
| 11 | | | 5% | Not crosslinked | / | / |
| 12 | | | 10% | Crosslinked | 239.4 ± 4.4 | 12.5 ± 2.2 |
| 13 | Polysiloxane 1 | Phosphoric | 1% | Not crosslinked | / | / |
| 14 | | acid | 2% | Not crosslinked | / | / |
| 15 | | | 5% | Not crosslinked | / | / |
| 16 | | | 10% | Not crosslinked | / | / |
| 17 | Polysiloxane 1 | Nitric acid | 1% | Not crosslinked | / | / |
| 18 | | | 2% | Not crosslinked | / | / |
| 19 | | | 5% | Not crosslinked | / | / |
| 20 | | | 10% | Not crosslinked | / | / |
| 21 | Polysiloxane 1 | Chloridric | 1% | Not crosslinked | / | / |
| 22 | | acid | 2% | Not crosslinked | / | / |
| 23 | | | 5% | Not crosslinked | / | / |
| 24 | | | 10% | Not crosslinked | / | / |
| 25 | Polysiloxane 1 | Sulfuric | 1% | Crosslinked | 258.3 ± 4.0 | 34.6 ± 2.2 |
| 26 | | acid | 2% | Crosslinked | 298.7 ± 7.0 | 18.8 ± 2.6 |
| 27 | | | 5% | Crosslinked | 297.5 ± 6.8 | 24.0 ± 0.2 |
| 28 | | | 10% | Crosslinked | 415.8 ± 10.6 | 55.8 ± 1.8 |
| 29 | Polysiloxane 1 | DBTL | 0.5% | Crosslinked | 255.0 ± 13.0 | 11.7 ± 0.9 |

TABLE 3
Examples of condensation-cured formulations with carbon nanotubes
(polysiloxane 2)

| | | | Catalyst | | | |
|---|---|---|---|---|---|---|
| No | Additive | Catalyst | Concentration | Result | G_{sw} (%) | E_{sw} (%) |
| 30 | 0.1% MWNT | TFA | 1% | Crosslinked | 364.7 ± 22.5 | 11.6 ± 0.7 |
| 31 | | | 2% | Crosslinked | 308.4 ± 13.5 | 8.0 ± 0.9 |
| 32 | | | 5% | Crosslinked | 201.7 ± 6.4 | 3.7 ± 1.9 |
| 33 | | | 10% | Crosslinked | 205.1 ± 21.2 | 6.8 ± 1.4 |
| 34 | 0.1% MWNT | DCA | 1% | Crosslinked | 369.8 ± 2.4 | 13.0 ± 0.3 |
| 35 | | | 2% | Crosslinked | 218.2 ± 2.0 | 11.4 ± 1.0 |
| 36 | | | 5% | Crosslinked | 215.0 ± 7.1 | 10.3 ± 1.1 |
| 37 | | | 10% | Crosslinked | 205.4 ± 2.5 | 10.9 ± 0.7 |
| 38 | 0.1% MWNT | TCA | 1% | Crosslinked | 270.4 ± 5.3 | 11.0 ± 0.8 |
| 39 | | | 2% | Crosslinked | 242.7 ± 2.6 | 10.9 ± 1.5 |
| 40 | | | 5% | Crosslinked | 247.7 ± 8.4 | 10.3 ± 0.6 |
| 41 | | | 10% | Crosslinked | 267.8 ± 17.5 | 8.5 ± 0.3 |
| 42 | 0.1% MWNT | Phosphoric | 1% | Not crosslinked | / | / |
| 43 | | acid | 2% | Not crosslinked | / | / |
| 44 | | | 5% | Not crosslinked | / | / |
| 45 | | | 10% | Not crosslinked | / | / |
| 46 | 0.1% MWNT | Nitric acid | 1% | Not crosslinked | / | / |
| 47 | | | 2% | Not crosslinked | / | / |
| 48 | | | 5% | Not crosslinked | / | / |
| 49 | | | 10% | Not crosslinked | / | / |
| 50 | 0.1% MWNT | Chloridric | 1% | Not crosslinked | / | / |
| 51 | | acid | 2% | Not crosslinked | / | / |
| 52 | | | 5% | Not crosslinked | / | / |
| 53 | | | 10% | Not crosslinked | / | / |
| 54 | 0.1% MWNT | Sulfuric | 1% | Crosslinked | 350.0 ± 4.1 | 28.1 ± 1.6 |
| 55 | | acid | 2% | Crosslinked | 325.0 ± 3.1 | 26.7 ± 1.3 |
| 56 | | | 5% | Crosslinked | 370.0 ± 7.0 | 35.8 ± 0.8 |
| 57 | | | 10% | Crosslinked | 369.2 ± 9.1 | 57.5 ± 2.9 |
| 58 | 0.1% MWNT | DBTL | 0.5% | Crosslinked | 242.0 ± 16 | 11.9 ± 2.0 |

TABLE 4
condensation-cured polysiloxane-1 formulations with and
without carbon nanotubes corresponding to FIG. 2 and 3,
all of which were fully cross-linked.

| | MWCNT | | Catalyst | | | |
|---|---|---|---|---|---|---|
| | concen- | | concen- | | | |
| | tration | | tration | | | |
| No | wt % | Catalyst | wt % | η, cP | E, MPa | G_{sw}, % |
| A | 0 | TFA | 0.1 | | | |
| B | 0.05 | TFA | 0.1 | | 0.90 ± 0.01 | 319 ± 11 |
| C | 0.1 | TFA | 0.5 | 9470 | — | — |
| D | 0.2 | TFA | 0.5 | | — | — |
| E | 0 | DBTL | 0.5 | | | |
| F | 0.05 | DBTL | 0.5 | | 1.02 ± 0.05 | 272 ± 2 |
| G | 0.1 | DBTL | 0.5 | 9470 | — | — |
| H | 0.2 | DBTL | 0.5 | | — | — |
| I | 0.1 | TCA | 2 | | | |
| J | 0.1 | TCA | 5 | | | |
| K | 0.1 | TCA | 10 | | | |
| L | 0.1 | TFA | 10 | | | |
| M | 0 | TCA | 2 | | | |
| N | 0 | TCA | 5 | | | |
| O | 0 | TCA | 10 | | | |
| P | 0 | TFA | 10 | | | |

1. Composition for the preparation of an anti-biofouling coating comprising:
a polymer fraction essentially consisting of polysiloxane;
a curing agent;
carbon nanotubes;
a metal-free catalyst consisting of an organic acid.

2. Composition according to claim 1, wherein the catalyst concentration in the composition is comprised between 2 and 10 wt %.

3. Composition according to claim 1, wherein the organic acid is halogenated.

4. Composition according to claim 3, wherein the organic acid is fluorinated.

5. Composition according to claim 4, wherein the organic acid comprises trifluoroacetic acid (TFA).

6. Composition according to claim 3, wherein the organic acid is chlorinated.

7. Composition according to claim 6, wherein the organic acid comprises trichloroacetic acid (TCA).

8. Composition according to claim 1, wherein said curing agent is vinyl triisopropenoxysilane.

9. Composition according to claim 1, wherein the amount of carbon nanotubes is comprised between 0.05 and 1 wt % of the total composition.

10. Composition according to claim 1, wherein the polysiloxane is polydimethylsiloxane.

11. Composition according to claim 10, wherein the molecular weight of the polydimethylsiloxane is comprised between 15000 and 25000 g/mol, preferably about 20000 g/mol.

12. Composition according to claim 11, wherein the polydispersity of the polydimethylsiloxane is about 1.85.

13. Composition according to claim 1, wherein the weight ratio between the curing agent and the polysiloxane is about 1:19, the carbon nanotubes being multiwall carbon nanotubes in a concentration comprised between 0.1 and 0.5 wt % and the catalyst concentration being about 5 wt %.

14. Anti-biofouling coating obtained from the composition according to claim 1.

15. Method for the protection of items in a marine environment against bio-fouling comprising the step of covering said items with the anti-biofouling coating of claim 14.
